(19) United States
(12) Patent Application Publication
(10) Pub. No.: US 2010/0217740 A1
(43) Pub. Date: Aug. 26, 2010

(54) SYSTEM FOR ENTERPRISE WIDE MANAGEMENT WORKBENCH AND METHOD THEREOF

(75) Inventors: Samson David, Bangalore (IN); Reena Ramachandran, Bangalore (IN); Lakshmi Narasimha Rao Gunda, Bilekahalli (IN); Gopinath Reddy Perla Venkata, Andhra Pradesh (IN); Pramod Prakash Panda, Orissa (IN)

Correspondence Address: LERNER, DAVID, LITTENBERG,;KRUMHOLZ & MENTLIK, 600 SOUTH AVENUE WEST, WESTFIELD, NJ, 07090, US

(73) Assignee: INFOSYS TECHNOLOGIES LIMITED, Bangalore (IN)

(21) Appl. No.: 12/714,781

(22) Filed: Mar. 1, 2010

(30) Foreign Application Priority Data
Nov. 26, 2008 (IN) 2948/CHE/2008

(51) Int. Cl. G06F 3/048; G06N 5/02

(52) U.S. Cl. 706/47; 715/771; 715/854

(57) ABSTRACT

A system for managing and reporting data from a plurality of data sources for at least one user is disclosed. The plurality of data sources contain data related to one or more undertakings of the at least one user. The system includes a data collection module that collects data from the plurality of data sources. Further, the system includes a processor that processes collected data to form a set of analytical data. Furthermore, the system includes a user interface to display the set of analytical data to the at least one user in the form of a report. The set of analytical data display a current state of the data collected from the plurality of data sources.

### BACKGROUND OF THE INVENTION

The invention relates generally to data integration and reporting and more particularly, to a system for enterprise wide management workbench and a method thereof.

Managers and leaders in a business organization require data from various sources to be analyzed frequently. For example, a manager in a software firm may want to analyze the time spent by his sub-ordinates on a project and at the same time may want to see deadlines associated with the project allocated to his sub-ordinates. This requirement makes a manager fetch data from two different data sources and use them simultaneously to take a cognitive decision.

As an organization grows in size, the amount of data that gets stored in enterprise wide data sources increases drastically. To generate analysis reports from this data, large numbers of systems are required. Hence, most of the organizations have a gamut of applications to handle different types of data. For example, there would be a performance tracker application to track performance related data of various employees. In addition, there would be an attendance tracker application to track attendance records of an employee. A manager will essentially have to access two applications if he/she needs to find out the performance matrix and attendance record of one of his/her sub-ordinates.

Hence, there is a need of a system and a method that can provide data analyses functionalities to a user in a collaborative fashion. The system needs to collect data from various sources and provide it to the user in a systematic fashion, without having the user to switch between applications.

### BRIEF SUMMARY OF THE INVENTION

In an embodiment of the present invention, a system for managing and reporting data from a plurality of data sources for at least one user is provided. The plurality of data sources contain data related to one or more undertakings of the at least one user. The system includes a data collection module that collects data from the plurality of data sources. Further, the system also includes a processor that processes collected data to form a set of analytical data. The set of analytical data display a current state of the data collected from the plurality of data sources. Furthermore, the system includes a user interface to display the set of analytical data to the at least one user.

In another embodiment of the present invention, a method for managing and reporting data from a plurality of data sources for at least one user is provided. The plurality of data sources contain data related to one or more undertakings of the at least one user. The method includes a step of collecting data from the plurality of data sources. Further, the method includes the step of processing data collected from the plurality of data sources to form a set of analyzed data. The method also includes the step of displaying the set of analyzed data to the at least one user in the form of a report.

In yet another embodiment of the present invention, a computer storage device tangibly embodying a plurality of instructions adapted for managing and reporting data from a plurality of data sources for at least one user is provided. The plurality of data sources contain data related to one or more undertakings of the at least one user. The computer storage device includes a computer readable medium that stores a program code adapted to collect data from the plurality of data sources. Further, the computer readable medium also stores a program code adapted to process collected data to form a set of analytical data. The set of analytical data display a current state of the data collected from the plurality of data sources. Furthermore, the computer readable medium stores a program code adapted for display the set of analytical data to the at least one user.

### BRIEF DESCRIPTION OF THE DRAWINGS

These and other features, aspects, and advantages of the present invention will be better understood when the following detailed description is read with reference to the accompanying drawings in which like characters represent like parts throughout the drawings, wherein:

FIG. 1 illustrates an environment with a plurality of data sources to be used by at least one user, in which the present invention can be practiced;

FIG. 2 illustrates a system for managing and reporting data from the plurality of data sources for the at least one user, in accordance with various embodiments of the present invention;

FIG. 3 illustrates a method for managing and reporting data from the plurality of data sources for the at least one user, in accordance with an embodiment of the present invention;

FIG. 4 is an exemplary screenshot of a display of a set of analytical data in the form of a report from the plurality of data sources, in accordance with an embodiment of the present invention;

FIG. 5 is an exemplary screenshot of a drill-down functionality available for the set of analytical data, in accordance with an embodiment of the present invention;

FIG. 6 is an exemplary screenshot of alerts generated by the system for managing and reporting data from the plurality of data sources, in accordance with an embodiment of the present invention;

FIG. 7 is an exemplary screenshot of alerts related to risks associated with the at least one user's one more undertakings, in accordance with an embodiment of the present invention;

FIG. 8 is an exemplary screenshot of future actions notification for the at least one user, in accordance with an embodiment of the present invention; and

FIGS. 9-11 are exemplary screenshots of reports of set of analytical data generated from one or more of the plurality of data sources, in accordance with various embodiments of the present invention.

### DETAILED DESCRIPTION

The following description is the full and informative description of the best method and system presently contemplated for carrying out the present invention which is known to the inventors at the time of filing the patent application. Of course, many modifications and adaptations will be apparent to those skilled in the relevant arts in view of the following description in view of the accompanying drawings and the appended claims. While the system and method described herein are provided with a certain degree of specificity, the present technique may be implemented with either greater or lesser specificity, depending on the needs of the user. Further, some of the features of the present technique may be used to get an advantage without the corresponding use of other features described in the following paragraphs. As such, the present description should be considered as merely illustrative of the principles of the present technique and not in limitation thereof, since the present technique is defined solely by the claims.

The present invention relates to a system and method for managing and reporting data from a plurality of data sources. The plurality of data sources contain data related to at least one user's one or more undertakings. The system described in conjunction with figures, in the following paragraphs, collects data from the plurality of data sources, processes the data to form a set of analytical data and displays the set of analytical data to the at least one user in the form of a report. The set of analytical data represents a current state of data collected from the plurality of data sources.

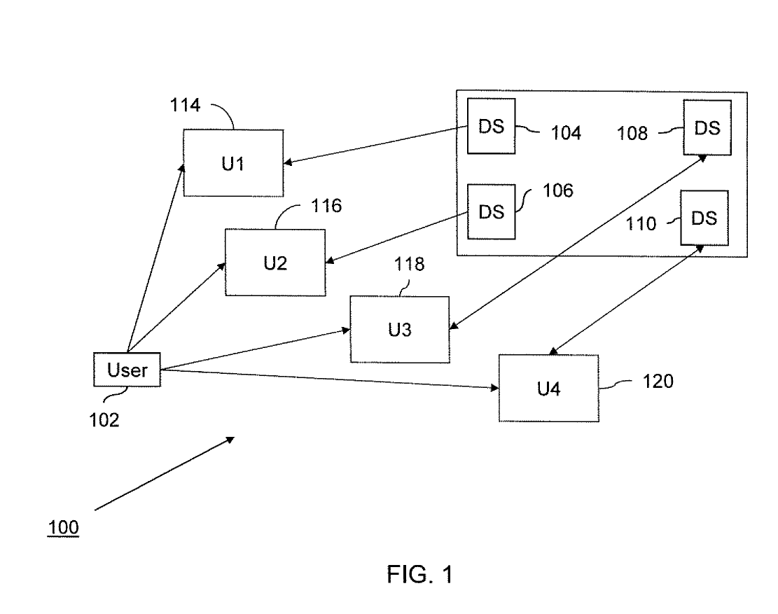

Referring now to figures, FIG. 1 illustrates an environment 100 with a plurality of data sources 104, 106, 108, 110 to be used by at least one user 102, in which the present invention can be practiced. The plurality of data sources 104, 106, 108, 110 store data for users across an organization. Example of data stored in the plurality of data sources include, but is not limited to, employee attendance record, time related data, sales target data, training data for employees, future milestone data etc. Data related to one or more undertakings of the at least one user 102 is also stored in the plurality of data sources 104, 106, 108, and 110. Examples of one or more undertakings of the at least one user include, but are not limited to, projects handled, resources allocated, contracts signed etc. Data related to the at least one users one or more undertakings is distinguished from data related to other users with the help of login credentials provided to the at least one user 102 by network administrators.

The at least one user 102, in his desire to track progress of his one or more undertakings, has to access the plurality of data sources 104, 106, 108, 110. As shown in FIG. 1, user-interface applications 114, 116, 118, and 120 are used to present data related to one or more undertakings of the at least one user 102. These applications are required to be accessed separately by the at least one user 102 to find information. The time required to get proper information hence, increases. Further, data stored in data source 104 may not be connected directly to data stored in data source 106. However, the at least one user 102 may wish to analyze data in these data sources together and find critical information. In such a case, the at least one user 102 has to access the user-interface applications corresponding to data sources 104 and 106 (U1 114, and U2 116) simultaneously and remember data from one of the data sources to co-relate it with data from the other data source.

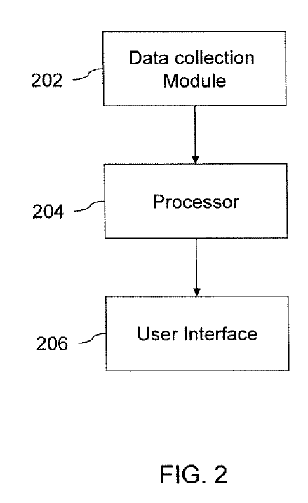

FIG. 2 illustrates a system for managing and reporting data from the plurality of data sources for the at least one user, in accordance with various embodiments of the present invention. The system includes a data collection module 202, a processor 204, and a user interface 206. The data collection module collects data from the plurality of data sources 104, 106, 108, and 110. The data collected is then processed by the processor 204 to generate a set of analyzed data. The user interface 206 then displays the set of analyzed data to the at least one user in the form of a report. The set of analyzed data display a current state of the data collected from the plurality of data sources 104, 106, 108, and 110.

When the at least one user 102 wishes to access data related to his one or more undertakings, he logs on to the system. The login credentials are used by the data collection module 202 to access data stored in the plurality of data sources 104, 106, 108, and 110 corresponding to the at least one user's one or more undertakings. The data stored in the plurality of data sources, in one embodiment of the present invention, can be performance data, or time related data, or sales target data, or future milestone data, or onsite employee related data, or training related data, or combinations thereof.

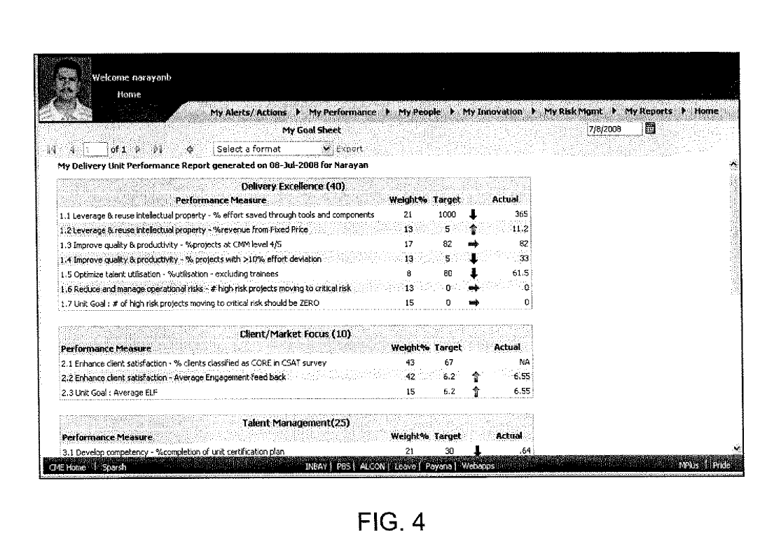

Further, the processor 204 is used to produce set of analytical data. According to one embodiment of the present invention, the at least one user 102 sets rules using a rules engine. The rules set by the at least one user 102 are used by the processor 204 to generate the set of analyzed data. Rules set by the user can, for example, be collecting data related to employees who have been in the office for less than 8 hours. The set of analytical data is finally displayed to the at least one user 102 in the form of a report on the user interface 206. The current state of the data collected from the plurality of data sources is displayed on the user interface in the form of symbols or colors. Screenshot of set of analytical data displayed to the at least one user 102 can be seen in FIG. 4. In the screenshot, the current state is represented with the help of arrows.

According to one embodiment of the present invention, a scorecard generation module is used to set targets for data from each of the plurality of data sources. As shown in the screenshot of FIG. 4, the goals column lists targets set for data from each of the plurality of data sources 104, 106, 108, and 110.

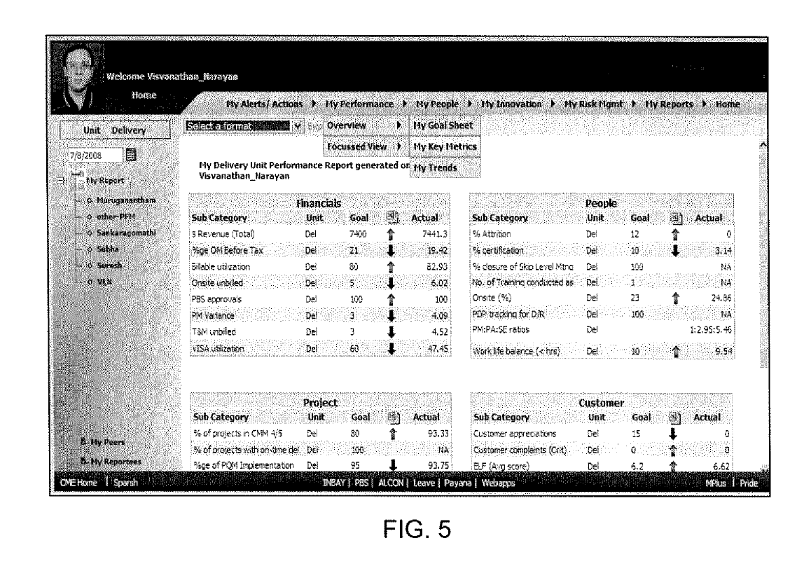

According to another embodiment of the present invention, the set of analyzed data can be drilled down to reach data collected from the plurality of data sources 104, 106, 108 and 110 using a drill-down module. The drill down module allows the at least one user 102 to reach to the data that led to the generation of the set of analyzed data. A screenshot of this functionality of the system for managing and reporting data is shown in FIG. 5

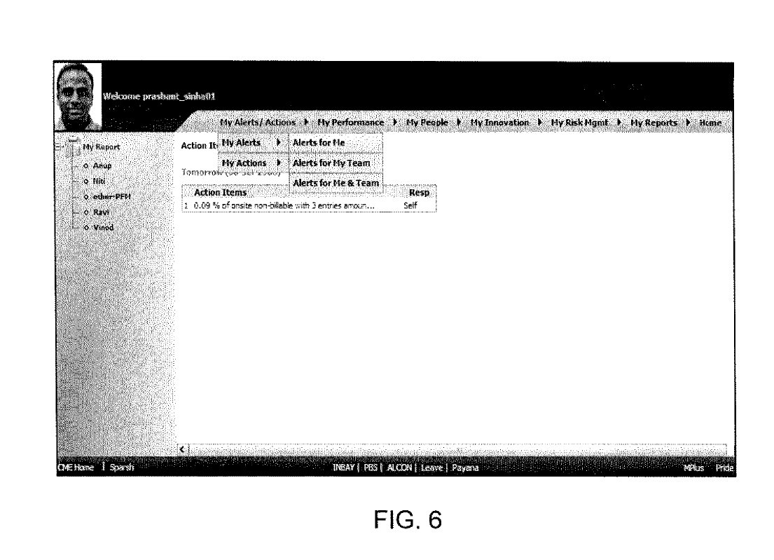

According to yet another embodiment of the present invention, an alerts and exception management module present in the system for managing and reporting data generates alerts for the at least one user 102 on the user interface 206 when data collected from the plurality of data sources 104, 106, 108, and 110 meets conditions set by the at least one user from the rules engine. A screenshot of alerts generated for the at least one user 102 can be seen in FIG. 6.

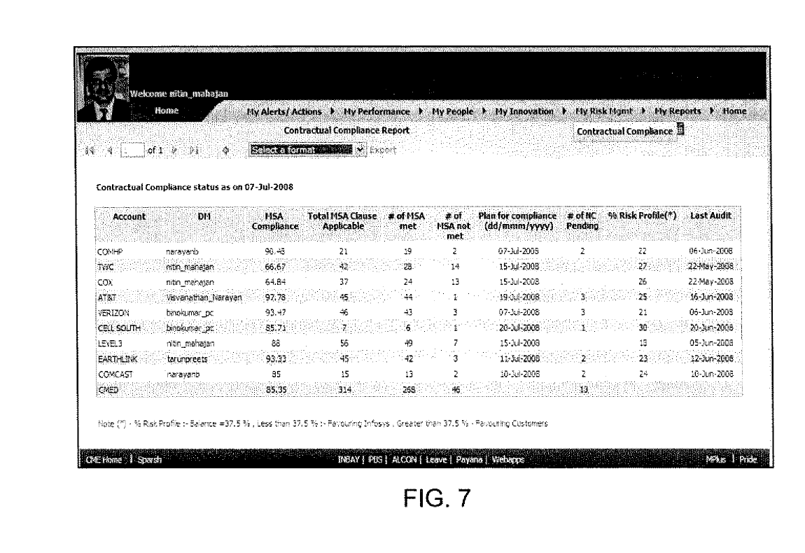

Further, the system, according to one embodiment of the present invention, includes a risks module that alerts the at least one user 10 of risks associated with his/her one or more undertakings based on data collected form the plurality of data sources. Examples of risks can be, contractual compliance conditions involved in a contract of work signed by the at least one user 102. An exemplary screenshot of the risk alerts generated by the risks module for the at least one user has been illustrated in FIG. 7.

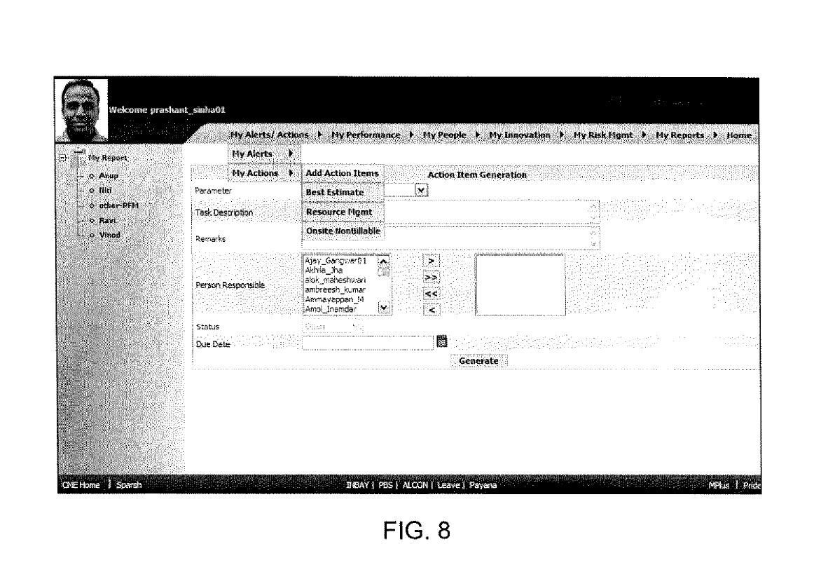

According to another embodiment of the present invention, the system includes a to-do actions module that updates the at least one user 102 with his/her future actions based on the set of analyzed data obtained from data collected from the plurality of data sources 104, 106, 108, and 110. For example, in case analyzed data from performance related data in one of the plurality of data sources shows that one or more sub-ordinates of the at least one user 102 has to complete some certifications, then the to-do actions module notifies the at least one user 102 to assign the task to the person responsible to follow-up the certification program for other employees. A screenshot of this functionality can be seen in FIG. 8.

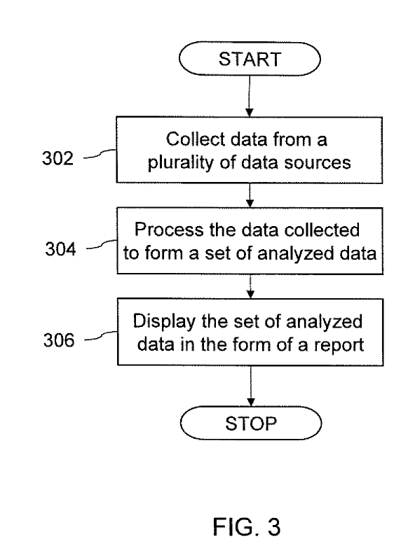

Referring now to FIG. 3, that illustrates a method for managing and reporting data from the plurality of data sources for the at least one user, in accordance with an embodiment of the present invention. At step 302, data from plurality of data sources is collected. Data present in the plurality of data sources relates to the at least one user's one or more undertakings. Further, at step 304, data collected from the plurality of data sources is processed to form a set of analyzed data. At step 306, the set of analyzed data is displayed to the at least one user 102 in the form of a report.

According to one embodiment of the present invention, the method includes the step of setting rules by the at least one user for data collected from the plurality of data sources. The rules set by the at least one user are used when collected data is analyzed. Further, the method includes the step of displaying alerts to the at least one user when data collected from the plurality of data sources meet the condition set in the rules. Further, the alerts generated are stored in a central repository for further analysis of data from the plurality of data sources.

According to another embodiment of the present invention, the method includes the step of alerting the at least one user of a risk associated with his/her one or more undertaking based on the set of analyzed data. Examples of risks can be, contractual compliance conditions involved in a contract of work signed by the at least one user 102.

Further, the method includes a step of setting targets for data collected from the plurality of data sources. The method also includes the step of displaying a current state of the data from the plurality of data sources by comparing the data collected from the plurality of data sources with the targets.

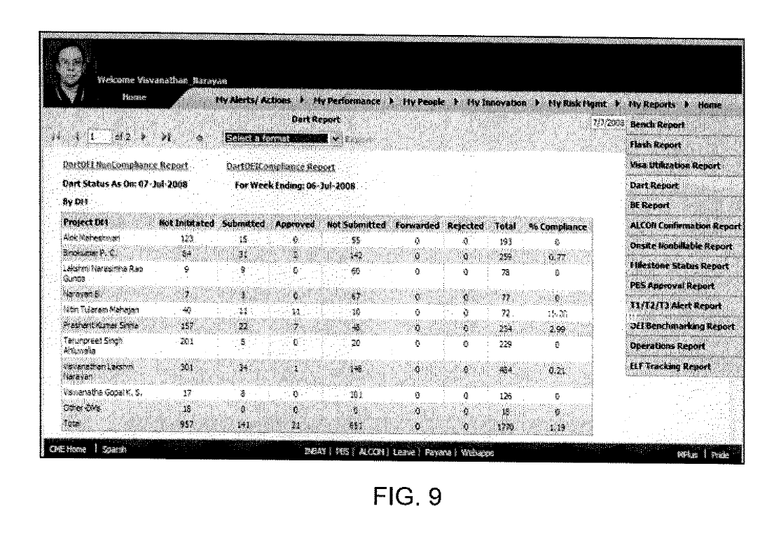

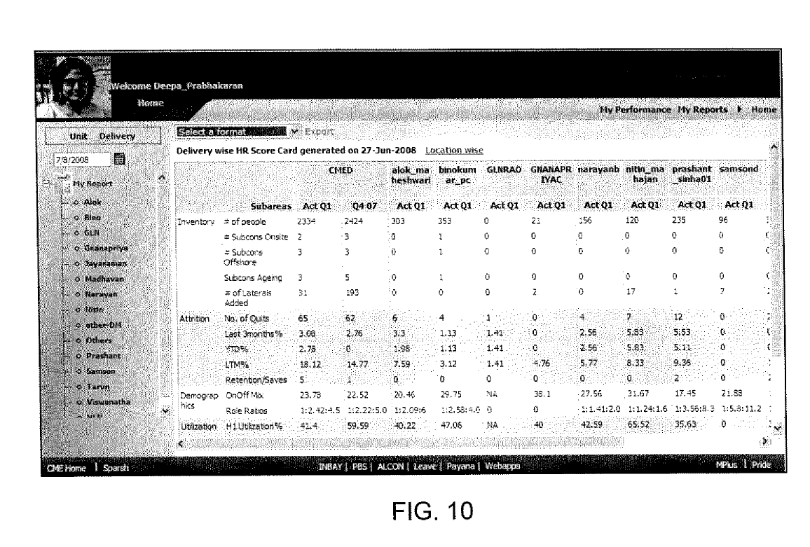

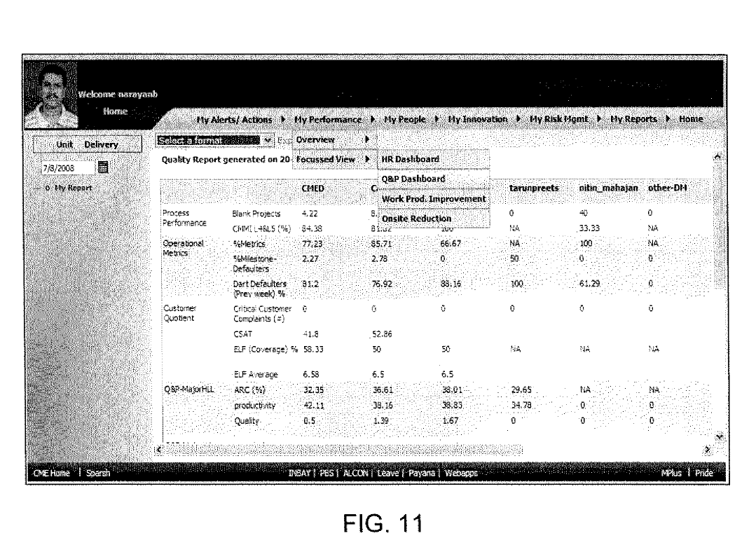

FIGS. 9-11 are exemplary screenshots of reports of set of analytical data generated from one or more of the plurality of data sources, in accordance with various embodiments of the present invention. Data from time related data source is collected for the sub-ordinates of at least one user and displayed in the form of a report as shown in FIG. 9. Further, data related to human resources allocated to the at least one user is collected and a report, as shown in the screenshot of FIG. 10, is generated. The report informs the at least one user of the number of people working on a project, number of people waiting to be allocated etc. Furthermore, data related to quality status of the at least one user's one or more undertakings is collected and a report, shown in FIG. 11, is displayed to the at least one user.

The system and method described in conjunction with figures, helps reduce the time spent by the at least one user to analyze data obtained from a plurality of data sources. The system also helps the at least one user take decisions that depend on data collected from different data sources and need to be analyzed at the same time. The system provides the at least one user with analytical data in a collaborative fashion and thus reduces the time spent by the at least one user in switching between different user-interface applications.

As will be appreciated by those ordinary skilled in the art, the foregoing example, demonstrations, and method steps may be implemented by suitable code on a processor base system, such as general purpose or special purpose computer. It should also be noted that different implementations of the present technique may perform some or all the steps described herein in different orders or substantially concurrently, that is, in parallel. Furthermore, the functions may be implemented in a variety of programming languages. Such code, as will be appreciated by those of ordinary skilled in the art, may be stored or adapted for storage in one or more tangible machine readable media, such as on memory chips, local or remote hard disks, optical disks or other media, which may be accessed by a processor based system to execute the stored code. Note that the tangible media may comprise paper or another suitable medium upon which the instructions are printed. For instance, the instructions may be electronically captured via optical scanning of the paper or other medium, then compiled, interpreted or otherwise processed in a suitable manner if necessary, and then stored in a computer memory.

While, the following description is presented to enable a person of ordinary skill in the art to make and use the invention and is provided in the context of the requirement for a obtaining a patent. The present description is the best presently-contemplated method for carrying out the present invention. Various modifications to the preferred embodiment will be readily apparent to those skilled in the art and the generic principles of the present invention may be applied to other embodiments, and some features of the present invention may be used without the corresponding use of other features. Accordingly, the present invention is not intended to be limited to the embodiment shown but is to be accorded the widest cope consistent with the principles and features described herein.

Many modifications of the present invention will be apparent to those skilled in the arts to which the present invention applies. Further, it may be desirable to use some of the features of the present invention without the corresponding use of other features.

Accordingly, the foregoing description of the present invention should be considered as merely illustrative of the principles of the present invention and not in limitation thereof.

1. A system for managing and reporting data from a plurality of data sources for at least one user, wherein the plurality of data sources contain data related to one or more undertakings of the at least one user, the system comprising:
a data collection module that collects data from the plurality of data sources;
a processor that processes collected data to form a set of analytical data; and
a user interface to display the set of analytical data to the at least one user in the form of a report, wherein the set of analytical data display a current state of the data collected from the plurality of data sources.

2. The system as recited in claim 1 further comprises a rules engine that allows the at least one user to set rules, wherein the rules are used by the processor while generating the set of analytical data.

3. The system as recited in claim 2 further comprises an alerts and exception management module that alerts the at least one user when data collected from the plurality of data sources meet a condition set in the rules.

4. The system as recited in claim 1 wherein the plurality of data sources comprise performance data, or time related data, or sales target data, or future milestone data, or onsite employee related data, or training related data, or combinations thereof.

5. The system as recited in claim 1 further comprises a scorecard generation module that allows the at least one user to set targets for data from each of the plurality of data sources.

6. The system as recited in claim 1 further comprises a risks module that alerts the at least one user of risk associated with his/her one or more undertakings based on data collected from the plurality of data sources.

7. The system as recited in claim 1 further comprises a to-do actions module that updates the at least one user with his/her future actions based on the set of analyzed data obtained from data collected from the plurality of data sources.

8. The system as recited in claim 1 further comprises a drill-down module that lets the at least one user to drill down the set of analyzed data to reach data collected from the plurality of data sources.

9. A method for managing and reporting data from a plurality of data sources for at least one user, wherein the plurality of data sources comprise data related to one or more undertakings of the at least one user, the method comprising:
collecting data from the plurality of data sources;
processing data collected from the plurality of data sources to form a set of analyzed data; and
displaying the set of analyzed data to the at least one user in the form of a report.

10. The method as recited in claim 9 further comprises setting rules by the at least one user for data from the plurality of data sources, wherein the rules are used when collected data is analyzed.

11. The method as recited in claim 10 further comprises displaying alerts to the at least one user when data collected from the plurality of data sources meet the condition set in the rules.

12. The method as recited in claim 11 further comprises storing the alerts generated in a central repository.

13. The method as recited in claim 10 further comprises alerting the at least one user of a risk associated with his/her one or more undertakings based on the set of analyzed data.

14. The method as recited in claim 10 further comprises setting targets for data from each of the plurality of data sources.

15. The method as recited in claim 14 further comprises displaying a current state of data from each of the plurality of data sources by comparing data collected from plurality of data sources with the targets.

16. A computer storage device tangibly embodying a plurality of instructions adapted for managing and reporting data from a plurality of data sources for at least one user, wherein the plurality of data sources comprise data related to one or more undertakings of the at least one user, comprising:
a computer readable medium storing:
a program code adapted to collect data from the plurality of data sources;
a program code adapted to process collected data to form a set of analytical data; and
a program code adapted for display the set of analytical data to the at least one user, wherein the set of analytical data display a current state of the data collected from the plurality of data sources.

17. The computer storage device as recited in claim 16 further comprises a program code adapted to set rules for data from the plurality of data sources, wherein the rules are used when collected data is analyzed.

18. The computer storage device as recited in claim 17 further comprises a program code adapted for displaying alerts to the at least one user when one or more data points from data collected meet the condition set in the rules.

19. The computer storage device as recited in claim 18 further comprises a program code adapted for storing the alerts generated in a central repository.

20. The computer storage device as recited in claim 16 further comprises a program code adapted for alerting the at least one user of a risk associated with his/her one or more undertakings based on the set of analyzed data.

21. The computer storage device as recited in claim 16 further comprises a program code adapted for:
setting targets for data from each of the plurality of data sources; and
displaying a current state of data from each of the plurality of data sources by comparing plurality of data points with the targets.
